(19) United States
(12) Patent Application Publication
(10) Pub. No.: US 2014/0132408 A1
(43) Pub. Date: May 15, 2014

(54) METHOD FOR OPERATING A TIRE PRESSURE MONITORING SYSTEM OF A MOTOR VEHICLE

(71) Applicant: Dr. Ing. h.c. F. Porsche Aktiengesellschaft, Stuttgart (DE)

(72) Inventors: Michael Baum, Tiefenbronn-Lehningen (DE); Dietmar Luz, Calw (DE)

(73) Assignee: Dr. Ing. h.c. F. Porsche Aktiengesellschaft, Stuttgart (DE)

(21) Appl. No.: 14/079,029

(22) Filed: Nov. 13, 2013

(30) Foreign Application Priority Data
Nov. 15, 2012 (DE) 102012111016.6

(51) Int. Cl. B60C 23/04

(52) U.S. Cl. CPC B60C 23/0408
USPC 340/442

(57) ABSTRACT

A method for operating a tire pressure monitoring system of a motor vehicle, including a direct or indirect sensing device for sensing and outputting the pressure which is present in the motor vehicle tires. In order to assist the driver of a vehicle when inflating a tire, a loudspeaker, which is present on the motor vehicle, is used to transmit the current pressure value (p_{act}) to the vehicle driver by a voice message. In this context, the voice message includes the current pressure values (p_{act}) in increments of 0.1 bar. The loudspeakers, which are present, are the loudspeakers of the vehicle's own multimedia system or a loudspeaker of the vehicle's own alarm system.

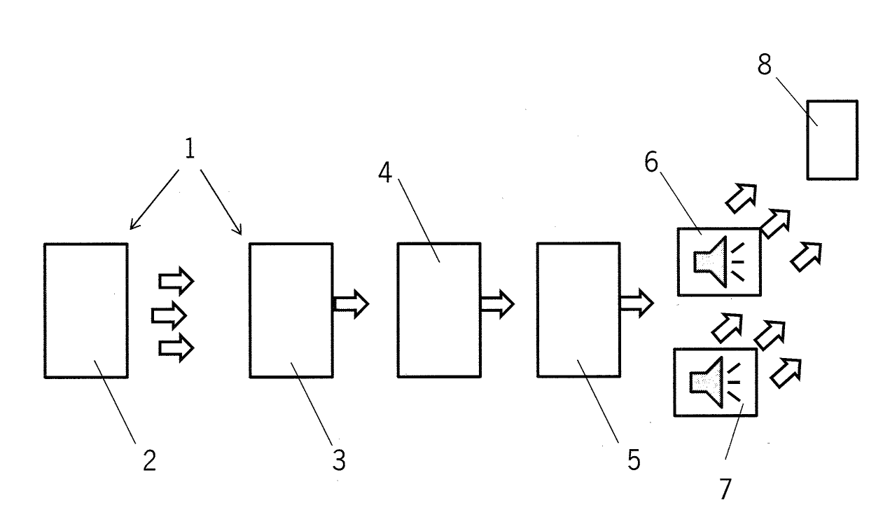

### CROSS-REFERENCE TO RELATED APPLICATIONS

This application claims priority to German Patent Application No. 10 2012 111 016.6, filed Nov. 15, 2012, which is incorporated by reference herein in its entirety.

### FIELD OF THE INVENTION

The present invention relates to a method for operating a tire pressure monitoring system of a motor vehicle, comprising a direct or indirect sensing device for sensing and outputting the pressure which is present in the motor vehicle tires.

### BACKGROUND OF THE INVENTION

DE 10 2004 040 790 A1, which is incorporated by reference herein, discloses a method for monitoring the inflation pressure of tires, in which a foot component, which is permanently and fixedly mounted in the vehicle, and a mobile component, which is provided with an input device for directly inputting the various wheel positions, are provided. The mobile component is moved into the vicinity of the individual wheels of the stationary vehicle and the wheel position is compared with a previously predefined identification number in order to carry out monitoring of the inflation pressure of tires. In the previously known method the mobile component is provided with an alarm device. The alarm device supplies a visual and/or audibly perceptible alarm signal. Furthermore, the alarm device supplies a voice output. The presence of the mobile component is less advantageous for reasons of comfort. In the previously known method for monitoring the inflation pressure of tires, an alarm can be issued visually or audibly/verbally.

### SUMMARY OF THE INVENTION

Described herein is a method for monitoring the inflation pressure of tires with the effect that the simplest possible method with improved feedback to the driver of a vehicle is implemented.

The method for operating a tire pressure monitoring system of a motor vehicle comprises a direct or indirect sensing device for sensing and outputting the pressure (p_{act}) which is present in the motor vehicle tires, wherein a loudspeaker which is present on the motor vehicle is used to transmit the current pressure value (p_{act}) to the vehicle driver by means of a voice message.

There is provision here that a loudspeaker which is present on the motor vehicle is used to transmit the current pressure value to the vehicle driver by means of a voice message. The loudspeaker which is present on the motor vehicle can be a loudspeaker of the vehicle's own multimedia system or a loudspeaker of the vehicle's own alarm system.

In one particularly advantageous development of the method according to the invention there is provision that the voice message can be output in a multilingual fashion, with the result that the language of the transmitted information can be selected.

A further advantageous development provides that information about the position of the wheel at which a change in the current pressure value and therefore in the inflation state of the motor vehicle tire is detected is output. The voice message is particularly advantageously configured in that the voice message outputs the current pressure values in increments of 0.1 bar.

The output signals of the direct or indirect sensing device for sensing and outputting the pressure which is present in the motor vehicle tires are transmitted to a control unit and processed and amplified by an amplifier of the vehicle's own multimedia system.

In a further development of the method according to aspects of the invention there is provision that the output signals of the direct or indirect sensing device for sensing and outputting the pressure which is present in the motor vehicle tires are transmitted to the control unit in a wireless fashion. In the method, the current pressure value represents a differential pressure value or an overpressure value in relation to the ambient pressure.

### BRIEF DESCRIPTION OF THE DRAWING

The drawing shows a schematic illustration of the components which are present in the vehicle and which are used to carry out the method according to aspects of the invention.

### DETAILED DESCRIPTION OF THE INVENTION

The drawing illustrates a tire pressure monitoring system 1 for motor vehicles. The tire pressure monitoring system 1 comprises a direct or indirect sensing device 2 and a control unit 3. A direct sensing device for sensing the pressure p_{act} which is present in the motor vehicle tires is formed from a pressure sensor (not illustrated) which is arranged in the tire of a motor vehicle and is battery operated. The measured pressure values p_{act}, which are determined as differential pressure values or overpressure values with respect to the ambient pressure, are transmitted to the control unit 3 in a wireless fashion. In addition, there are also indirect sensing devices 2, which can also reliably sense the pressure p_{act} which is present in the motor vehicle tires. The circumference of the wheels and therefore also the air pressure can be determined from the comparison of the wheel speeds of all the four wheels. Such a calculation or estimation of the air pressure in the tires takes place in the control unit 3.

As is apparent from the drawing, the sensing device 2 transmits its output signals to the control device 3. The output signals of the direct or indirect sensing device 2 are transmitted to the control unit 3 in a wireless fashion here. The control unit 3 is connected to an on-board computer 4, which is in turn connected to a vehicle-dedicated multimedia system 5. The multimedia system 5 has loudspeakers 6 in the passenger compartment of the vehicle. These loudspeakers 6 in the passenger compartment of the vehicle are actuated by the multimedia system 5. Alternatively, the multimedia system 5 can actuate the loudspeakers 7 of an alarm system which is present in the motor vehicle. These loudspeakers 7 of the alarm system of the motor vehicle are embodied as piezo loudspeakers 7 and are typically not arranged in the passenger compartment of the motor vehicle but rather outside the passenger compartment of the motor vehicle. When the loudspeakers 6, 7 are actuated, an audio message is transmitted to the driver of the vehicle. This is denoted schematically in the drawing with the reference symbol 8 for representing the ear of the driver of the vehicle.

Motor vehicles generally have an already mentioned sensing device 2 for sensing and outputting the pressure p_{act} which is present in the motor vehicle tires. There are numerous methods for indicating to the driver of a vehicle when the correct tire pressure has been reached when a tire is being inflated with compressed air. For example, the time to end the inflation of the tire is known by means of the light system of the motor vehicle or by means of audible information such as the horn and similar signal generators. The present invention provides that a loudspeaker 6, 7 which is present on the motor vehicle is used to transmit the current pressure value p_{act} to the driver of the vehicle by means of a voice message. Precise voice-activated control with specific pressure values in 0.1 bar increments by means of the outwardly directed piezo loudspeaker 7 of the alarm system or by means of the loudspeakers 6 of the multimedia system 5 of the motor vehicle constitutes a particularly simple and efficient way of transmitting to the driver of the vehicle. The driver of the vehicle selects a menu item inflation aid in the on-board computer 4 and, if the motor vehicle is stationary, is provided with an indication of the difference between the pressure values and the required setpoint pressure at all four wheel positions. For this purpose, the driver of the vehicle selects on the on-board computer 4 that the means for indicating the differential pressure is provided with a voice output. The current pressure value p_{act} is then transmitted to the driver of the vehicle by means of a voice message.

On the on-board computer 4 it is possible to select that the voice message can be output in a multilingual fashion. As a result, the language of the transmitted information can be freely selected. As already mentioned, the voice message comprises the current pressure values p_{act} of the pressure p_{act} which is present in the motor vehicle tires, and outputs these pressure values p_{act} in increments of 0.1 bar. By means of this measure, the driver of the vehicle slowly approaches the required setpoint pressure without having to look at a display in the process. At the same time, the driver of the vehicle is not surprised by the setpoint pressure value being reached excessively quickly and possibly exceeding the required setpoint pressure recommendation.

In addition to the current pressure values p_{act} in increments of 0.1 bar, the voice message at the start of the inflation process also contains information about that wheel position at which a change in the current pressure value p_{act} and therefore in the inflation state of the motor vehicle tire has been detected by the sensing device 2.

The output signals of the direct or indirect sensing device 2 are transmitted to the control unit 3 in a wireless fashion. In order to amplify the low-frequency signal, the amplifier which is present for the vehicle's own multimedia system is used. The output signals of the direct or indirect sensing device 2 are therefore transmitted to the control unit 3 and subsequently processed and amplified by the amplifier of the vehicle's own multimedia system 5.

The driver of the motor vehicle is assisted by a voice message when inflating the tires with compressed air. For this purpose, the voice message contains the current pressure values p_{act} in increments of 0.1 bar of the respective tire, just up to which the driver of the vehicle carries out inflation. By virtue of this measure, when inflating a tire the driver of a vehicle no longer has to interrupt the inflation process in order to read the pressure difference with respect to the desired setpoint pressure on a display instrument. Furthermore, the driver of the vehicle is assisted in rapidly and precisely inflating the tire pressure.

What is claimed:

1. A method for operating a tire pressure monitoring system of a motor vehicle, comprising the steps of sensing and outputting a pressure (p_{act}) which is present in a tire of the motor vehicle using a direct or indirect sensing device, and transmitting a current pressure value (p_{act}) to the vehicle driver by means of a voice message using a speaker which is present on the motor vehicle.

2. The method as claimed in claim 1, wherein the voice message is configured to be output in a multilingual fashion, and a language of the transmitted information is configured to be selected.

3. The method as claimed in claim 1, wherein the speaker is a speaker of a multimedia system of the vehicle or a speaker of an alarm system of the vehicle.

4. The method as claimed in claim 1, further comprising the step of outputting information about a position of the tire at which a change in the current pressure value (p_{act}) is detected.

5. The method as claimed in claim 1, wherein the voice message outputs the current pressure values (p_{act}) in increments of 0.1 bar.

6. The method as claimed in claim 1, wherein output signals of the direct or indirect sensing device are transmitted to a control unit and processed and amplified by an amplifier of a multimedia system of the vehicle.

7. The method as claimed in claim 6, wherein the output signals of the direct or indirect sensing device are transmitted to the control unit in a wireless fashion.

8. The method as claimed in claim 1, wherein the current pressure value (p_{act}) represents a differential pressure value or an overpressure value in relation to an ambient pressure.
